(19) United States
(12) Patent Application Publication
(10) Pub. No.: US 2024/0005198 A1
(43) Pub. Date: Jan. 4, 2024

(54) MACHINE LEARNING MODEL FOR COMPUTING FEATURE VECTORS ENCODING MARGINAL DISTRIBUTIONS

(71) Applicant: Willis Group Limited, London (GB)

(72) Inventors: Bradley Curtis LACKEY, Redmond, WA (US); Yakoub Hassanov YAKOUBOV, Reigate (GB)

(73) Assignee: Willis Group Limited, London (GB)

(21) Appl. No.: 17/810,245

(22) Filed: Jun. 30, 2022

(51) Int. Cl. G06N 20/00

(52) U.S. Cl. CPC G06N 20/00

(57) ABSTRACT

A computing system including one or more processors configured to, during a runtime phase, receive a plurality of input marginal distributions. The one or more processors may be further configured to receive one or more dependencies between a plurality of the input marginal distributions. The one or more processors may be further configured to compute a respective plurality of input distribution feature vectors that encode the plurality of input marginal distributions. Based at least in part on the plurality of input distribution feature vectors and the one or more dependencies, the one or more processors may be further configured to compute, at a first trained machine learning model, one or more first output distribution feature vectors that encode one or more first output marginal distributions, respectively. The one or more processors may be further configured to output the one or more first output distribution feature vectors.

### TECHNICAL FIELD

This invention relates generally to modeling stochastic processes. Particularly, but not exclusively, the invention relates to modeling correlated distributions that executes faster and more efficiently on processor hardware than conventional methods of marginal distribution simulation modeling.

### BACKGROUND

Models of correlated stochastic processes are used in fields such as weather forecasting, electrical grid management, supply chain management, and insurance. The inputs to these models may be statistical distributions of various quantities, and the outputs of these models may be statistical distributions of output variables that provide information that can be used to determine actions to be taken, and/or control one or more devices or systems. For example, in energy-related applications, estimates of renewable energy outputs, such as availability of wind, solar, and hydroelectric power resources, drive scheduling of other power generation resources to meet demand. The inputs to a model may be sufficiently correlated that obtaining accurate outputs from the model requires representing the dependencies between the input distributions.

In order to accurately model the dependencies between input distributions and their effects on the output distributions, existing models frequently encode nonlinear behaviors. These nonlinear behaviors may model complex interactions in the system a model simulates. However, such models of correlated stochastic processes may have high computational complexity and may take long periods of time to execute. The high computational complexity of such models may make them impractical to use for large datasets or in highly time-sensitive settings. Aspects and embodiments of the invention have been devised with the foregoing in mind.

### SUMMARY

According to one aspect of the present disclosure, a computing system is provided, including one or more processors configured to, during a runtime phase, receive a plurality of input marginal distributions. The one or more processors may be further configured to receive a one or more dependencies between two or more of the input marginal distributions. The one or more processors may be further configured to compute a respective plurality of input distribution feature vectors that encode the plurality of input marginal distributions. Based at least in part on the plurality of input distribution feature vectors and one or more dependencies, the one or more processors may be further configured to compute, at a first trained machine learning model, one or more first output distribution feature vectors that encode one or more first output marginal distributions, respectively. The one or more processors may be further configured to output the one or more first output distribution feature vectors.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an example computing environment at which correlated stochastic processes may be modeled.

FIG. 2 schematically shows an example computing system including one or more processors when a first trained machine learning model receives a plurality of input distribution feature vectors and one or more dependencies, according to the example of FIG. 1.

FIG. 3 schematically shows the first trained machine learning model and a second trained machine learning model when the second trained machine learning model receives an output of the first trained machine learning model, according to the example of FIG. 1.

FIG. 4 schematically shows the first trained machine learning model, the second trained machine learning model, and a third trained machine learning model when the second trained machine learning model receives outputs of the first trained machine learning model and the third trained machine learning model, according to the example of FIG. 3.

FIG. 5A schematically shows a target model that the first trained machine learning model is trained to simulate, according to the example of FIG. 1.

FIG. 5B schematically shows computing processes at which a training data set for the first trained machine learning model is generated, according to the example of FIG. 5A.

FIG. 6 schematically shows the first trained machine learning model during a training phase, according to the example of FIG. 5B.

FIG. 7A shows a flowchart of an example method for use with a computing system at which the first trained machine learning model is executed during a runtime phase, according to the example of FIG. 1.

FIGS. 7B-7C show additional steps of the method of FIG. 7A that may be performed in some examples.

FIG. 8A shows a flowchart of an example method by which the first trained machine learning model may be trained at the computing system during a training phase that occurs prior to the runtime phase, according to the example of FIG. 7A.

FIG. 8B shows additional steps of the method of FIG. 8A that may be performed in some examples when generating the training data set for the first trained machine learning model.

FIG. 9 shows a schematic view of an example computing environment in which the computing system of FIG. 2 may be instantiated.

### DETAILED DESCRIPTION

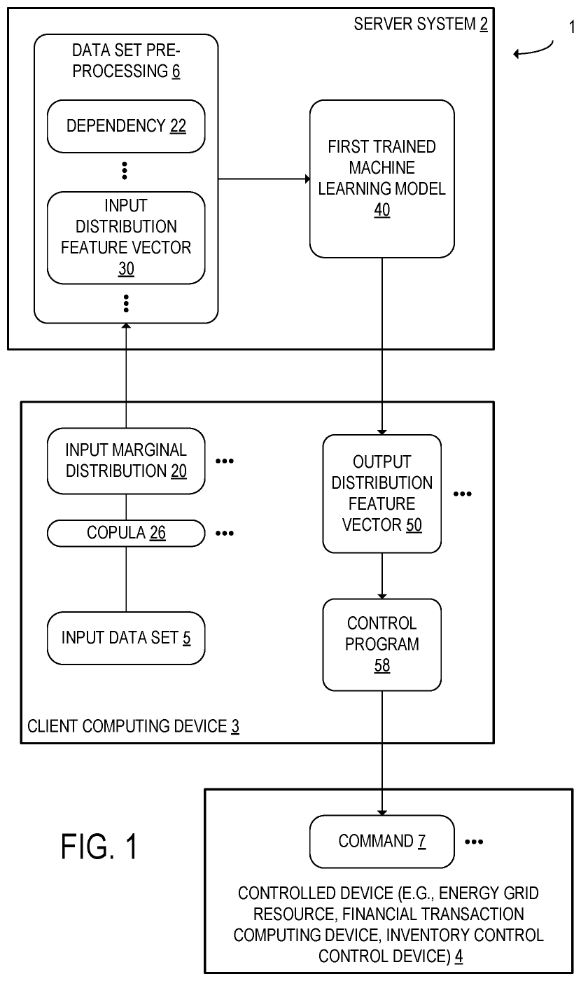

FIG. 1 schematically shows an example computing environment 1 at which correlated stochastic processes may be modeled in a manner that addresses the challenges discussed above. The computing environment 1 of FIG. 1 may include a server system 2, a client computing device 3, and a controlled device 4. At the client computing device 3, a plurality of input marginal distributions 20 and one or more copulas 26 may be computed from an input data set 5 and transmitted to the server system 2. At the server system 2, data set pre-processing 6 may be performed to compute one or more dependencies 22 from the copulas 26. The data set pre-processing 6 may further include encoding the input marginal distributions as a respective plurality of input distribution feature vectors 30. The dependencies 22 and the input distribution feature vectors 30 may be input into a first trained machine learning model 40 at which a plurality of output distribution feature vectors 50 are computed. As discussed in further detail below, the first trained machine learning model 40 may have been trained to simulate a target model.

The server system may transmit the output distribution feature vectors 50 to the client computing device 3. Based at least in part on the output distribution feature vectors 50, the client computing device 3 may generate one or more commands 7 for the controlled device 4 at a control program 58. The controlled device 4 may, for example, be a device that is included in an energy grid and is configured to supply electrical power. As another example, the controlled device 4 may be a financial transaction computing device at which financial transactions may be programmatically performed. As a third example, the controlled device 4 may be an inventory control computing device configured to set safety stock levels. The controlled device 4 may be configured to programmatically execute the one or more commands 7 received from the client computing device 3.

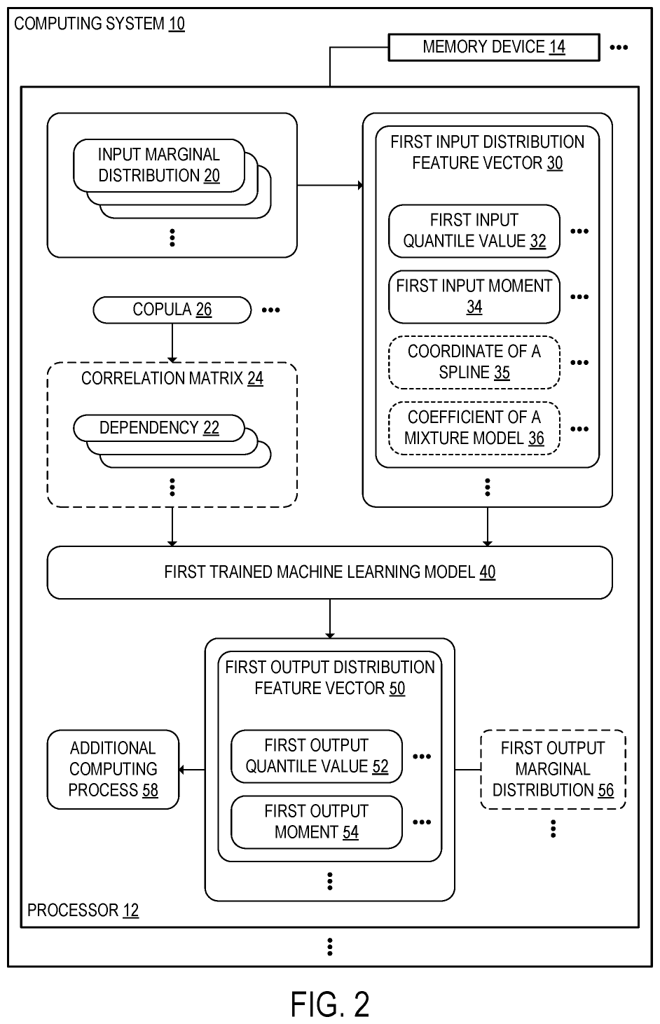

FIG. 2 schematically depicts a computing system 10 that may be included in the example computing environment 1 of FIG. 1. For example, the computing system 10 may instantiate the server system 2. The computing system 10 may include one or more processors 12 that are configured to execute instructions to perform computing processes. The computing system 10 may further include one or more memory devices 14 that are communicatively coupled to the one or more processors 12. The one or more memory devices 14 may, for example, include one or more volatile memory devices and/or one or more non-volatile memory devices.

The computing system 10 may be instantiated in a single physical computing device or in a plurality of communicatively coupled physical computing devices. For example, at least a portion of the computing system 10 may be provided as a server computing device located at a data center. In such examples, the computing system 10 may further include one or more client computing devices configured to communicate with the one or more server computing devices over a network.

FIG. 2 shows the one or more processors 12 of the computing system 10 during a runtime phase. At the runtime phase, the one or more processors 12 may be configured to receive a plurality of input marginal distributions 20. The plurality of input marginal distributions 20 may be probability or frequency distributions. Each of the plurality of input marginal distributions 20 may indicate, for a plurality of values of respective independent variable, a corresponding plurality of probabilities or frequencies of different values of a dependent variable. The plurality of input marginal distributions 20 may each have different independent-variable-dependent-variable combinations. In some examples, the plurality of input marginal distributions 20 may be distributions of one dependent variable (e.g. total energy demand) over a plurality of different independent variables. Alternatively, the plurality of input marginal distributions 20 may include distributions of a plurality of different dependent variables (e.g., available supply of energy from different energy sources) over a plurality of independent variables.

During the runtime phase, the one or more processors 12 may be further configured to receive one or more dependencies 22 between two or more of the input marginal distributions 20. In some examples, the one or more dependencies 22 may be one or more correlation coefficients between the pairs of the input marginal distributions 20. The correlation coefficients may, in such examples, be indicated in a correlation matrix 24. The correlation matrix 24 may be an N×N matrix, where N is the number of input marginal distributions 20. Alternatively, the dependencies 22 may be specified in some other type of data structure.

In some examples, the one or more processors 12 may be configured to compute the one or more dependencies 22 at least in part by computing a copula 26 over two or more respective variables of two or more of the input marginal distributions 20. The copula 26 may be used as an input with which the one or more dependencies 22 are computed. For example, the copula 26 may be a Gaussian copula. In such examples, the one or more dependencies 22 may be correlation coefficients of the copula 26. In other examples, the one or more copulas 26 may some other type of copula such as a Clayton copula, a Gumbel copula, or a T copula. In examples in which the dependencies 22 are indicated in a correlation matrix 24, the one or more processors 12 may be further configured to utilize the copula 26 when computing the correlation matrix 24.

In some examples, the one or more processors 12 may be configured to receive the one or more copulas 26 as empirical copulas that includes empirical data. In such examples, the copulas 26 may further include a portion that is computed synthetically at the one or more processors 12.

Subsequently to receiving the plurality of input marginal distributions 20, the one or more processors 12 may be further configured to compute a respective plurality of input distribution feature vectors that encode the plurality of input marginal distributions 20. In the example of FIG. 2, the input distribution feature vectors are a plurality of first input distribution feature vectors 30. As discussed in further detail below, one or more additional sets of input distribution feature vectors may also be computed for other sets of input marginal distributions. By encoding the plurality of input marginal distributions 20 as first input distribution feature vectors 30, the plurality of input marginal distributions 20 may be compressed such that they may subsequently be processed using fewer computing resources.

As depicted in the example of FIG. 2, the plurality of first input distribution feature vectors 30 may each include a corresponding plurality of first input quantile values 32 for the corresponding input marginal distribution 20. In one example, the first input quantile values 32 for an input marginal distribution 20 may be the quantile values located at 0.500, 0.900, 0.950, 0.990, and 0.995 significance levels in the input marginal distribution 20. In other examples, some other set of quantile values may be included in the first input distribution feature vector 30.

The plurality of first input distribution feature vectors 30 may further include, for each of the plurality of input marginal distributions 20, a corresponding plurality of first input moments 34. The plurality of first input moments 34 included in the first input distribution feature vector 30 generated for an input marginal distribution 20 may, for example, include a mean, a variance, a skewness, a kurtosis, and a hyperskewness of the input marginal distribution 20. The plurality of first input moments 34 may include higher-order moments in some examples or may exclude one or more of the moments listed above. The plurality of first input moments 34 may be expressed in raw form or central form in the first input distribution feature vector 30.

By expressing the first input distribution feature vector 30 with the plurality of first input quantile values 32 and the plurality of first input moments 34, the shape of the corresponding input marginal distribution 20 may be described in a form that is more efficient to process in terms of processor utilization, memory utilization, and time, in comparison to utilizing the input marginal distribution 20 in its uncompressed form. As discussed in further detail below, the plurality of first input distribution feature vectors 30 are more conducive to processing with machine learning models than the raw input marginal distributions 20 due to being encoded in the form of vectors.

In some examples, as an alternative to a plurality of first input quantile values 32 and a plurality of first input moments 34, the first input distribution feature vector 30 may alternatively include a plurality of coordinates of a spline 35 or a plurality of coefficients of a mixture model 36.

Subsequently to encoding the plurality of input marginal distributions 20 with the plurality of first input distribution feature vectors 30, the one or more processors 12 may be further configured to input the plurality of first input distribution feature vectors 30 and the one or more dependencies 22 into a first trained machine learning model 40. The first trained machine learning model 40 may be a deep neural network configured to receive the plurality of first input distribution feature vectors 30 and the one or more dependencies 22 at an input layer. At the first trained machine learning model 40, the one or more processors 12 may be further configured to compute one or more first output distribution feature vectors 50 based at least in part on the plurality of input distribution feature vectors 30 and the one or more dependencies 22.

At an output layer of the first trained machine learning model 40, the one or more processors 12 may be further configured to output the one or more first output distribution feature vectors 50. The one or more first output distribution feature vectors 50 may be output to one or more additional computing processes 58.

The one or more first output distribution feature vectors 50 may encode one or more first output marginal distributions 56, respectively. In some examples, the one or more processors 12 may be further configured to compute one or more estimates of the one or more first output marginal distributions 56 from the one or more first output distribution feature vectors 50. In such examples, the additional computing process 58 to which the one or more processors 12 output the one or more first output distribution feature vectors 50 may be a graphical user interface (GUI) generation module at which visual representations of the one or more first output marginal distributions 56 are generated for display to a user at a display device. As another alternative, the one or more additional computing processes may be downstream programs configured for specific use case scenarios. For example, in the use case scenarios discuss below, an energy grid resource deployment program may be configured to receive predicted distributions of electrical power source availability, or insurance risk evaluation program may be configured to receive predictions of aggregate risk for use in decision making according to predetermined program logic. As another example, the additional computing process 58 may be an inventory management system configured to receive predicted demand forecasts for use in inventory pooling and safety stock placement.

Each of the one or more first output distribution feature vectors 50 may include a plurality of first output quantile values 52 and a plurality of first output moments 54 for a corresponding first output marginal distribution 56 of the one or more first output marginal distributions 56. In some examples, similarly to the plurality of first input distribution feature vectors 30, the one or more first output distribution feature vectors 50 may each include quantile values located at 0.500, 0.900, 0.950, 0.990, and 0.995 significance levels in the first output marginal distribution 56. Each of the one or more first output distribution feature vectors 50 may further include a mean, a variance, a skewness, a kurtosis, and a hyperskewness of the first output marginal distribution 56. Other sets of first output quantile values 52 and/or first output moments 54 may be included in each first output distribution feature vector 50 in other examples.

As discussed in further detail below, the first trained machine learning model 40 may be a proxy of a more complex predictive model that has higher compute costs. Thus, at the first trained machine learning model 40, the one or more processors 12 may be configured to reproduce the output of the complex model in the form of the one or more first output distribution feature vectors 50. Similarly to the first input distribution feature vectors 30, each of the one or more first output distribution feature vectors 50 may be compressed relative to the first marginal output distribution 56 it encodes, thereby allowing for more efficient computing of further outputs related to the first output marginal distribution 56.

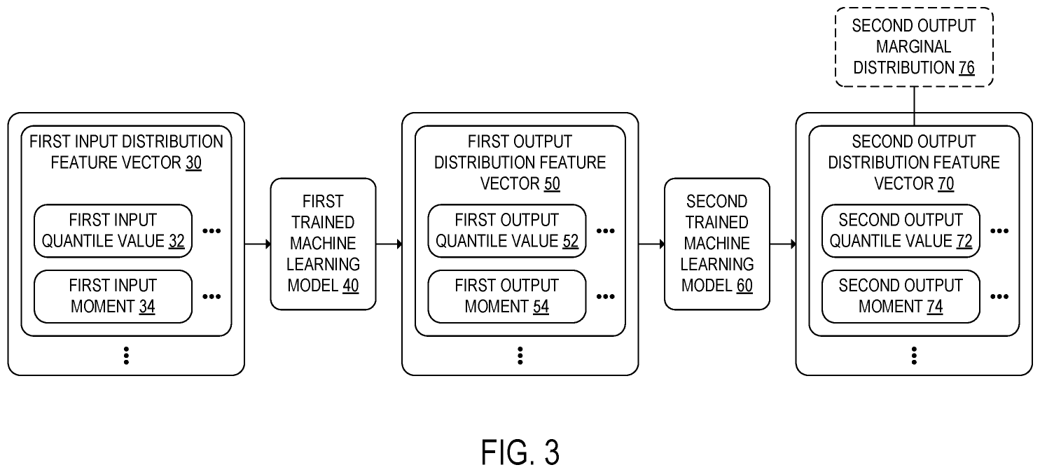

In some examples, as schematically depicted in FIG. 3, the one or more processors 12 may be further configured to execute a second trained machine learning model 60 that is configured to receive the one or more first output distribution feature vectors 50 as input. The second trained machine learning model 60 is configured to receive a plurality of distribution feature vectors as input, which may include a plurality of first output distribution feature vectors 50 and/or one or more distribution feature vectors from some other input source.

At the second trained machine learning model 60, based at least in part on the one or more first output distribution feature vectors 50, the one or more processors 12 may be further configured to compute one or more second output distribution feature vectors 70. The one or more processors 12 may be further configured to output the one or more second output distribution feature vectors 70.

The one or more second output distribution feature vectors 70 may encode one or more second output marginal distributions 76, respectively. As shown in the example of FIG. 3, each of the one or more second output distribution feature vectors 70 may include a plurality of second output quantile values 72 and a plurality of second output moments 74 of the corresponding second output marginal distribution 76. In some examples, the one or more second output distribution feature vectors 70 may have a same format as the plurality of first input distribution feature vectors 30 and the one or more first output distribution feature vectors 50.

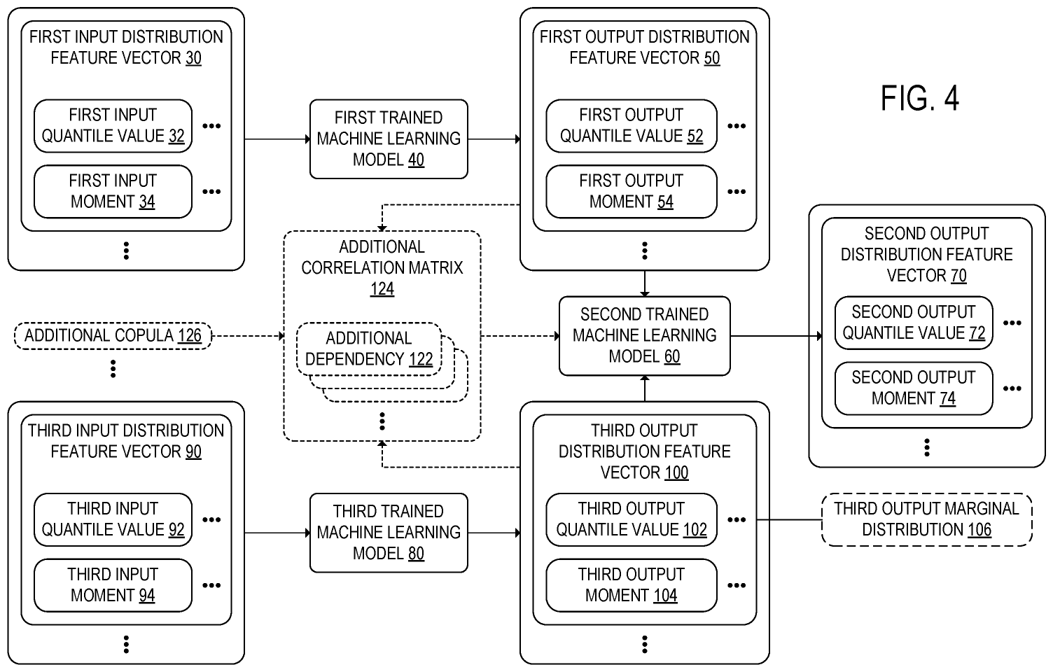

In some examples, as schematically shown in FIG. 4, the one or more processors 12 may be configured to execute three or more trained machine learning models that are configured to receive distribution feature vectors as input and/or produce distribution feature vectors as output. In the example of FIG. 4, at a third trained machine learning model 80, the one or more processors 12 are further configured to compute one or more third output distribution feature vectors 100 based at least in part on a plurality of third input distribution feature vectors 90. The plurality of third input distribution feature vectors 90 may each include a plurality of third input quantile values 92 and a plurality of third input moments 94. In addition, the one or more third output distribution feature vectors 100 may each include a plurality of third output quantile values 102 and a plurality of third output moments 104. The one or more third output distribution feature vectors 100 may respectively encode one or more third output marginal distributions 106.

In the example of FIG. 4, the second trained machine learning model 60 is further configured to receive the one or more third output distribution feature vectors 100 as input when the one or more second output distribution feature vectors 70 are computed. Thus, the second trained machine learning model 60 is configured to receive distribution feature vectors from both the first trained machine learning model 40 and the third trained machine learning model 80.

The inputs and outputs of machine learning models executed at the one or more processors 12 may be arranged according to structures other than those shown in FIGS. 3 and 4. In some examples, the second trained machine learning model 60 may be configured to receive distribution feature vectors from three or more trained machine learning models. The inputs to the second machine learning model 60 may additionally or alternatively include one or more additional input distribution feature vectors that are not received from a machine learning model. Additionally or alternatively, the second trained machine learning model 60 may be configured to output second output distribution feature vectors 70 to one or more additional machine learning models. The plurality of machine learning models may, in the general case, be arranged in any directed acyclic graph.

The one or more processors 12 may, as shown in the example of FIG. 4, be further configured to receive one or more additional dependencies 122 between a plurality of marginal distributions including the one or more first output marginal distributions 56 and the one or more third output marginal distributions 106, as encoded by the one or more first output distribution feature vectors 50 and the one or more third output distribution feature vectors 100. In some examples, the one or more processors 122 may be configured to receive one or more additional copulas 126 from which the one or more additional dependencies 122 may be computed. For example, the one or more additional copulas 126 may include one or more Gaussian copulas. In such examples, the one or more additional dependencies 122 may be correlation coefficients between the plurality of marginal distributions and may be included in an additional correlation matrix 124. The second trained machine learning model 60 may be further configured to receive of the one or more additional dependencies 122 as input when the one or more second output distribution feature vectors 70 are computed. Thus, the second trained machine learning model 60 may be configured to account for dependencies between the one or more first output distribution feature vectors 50 and the one or more third output distribution feature vectors 100.

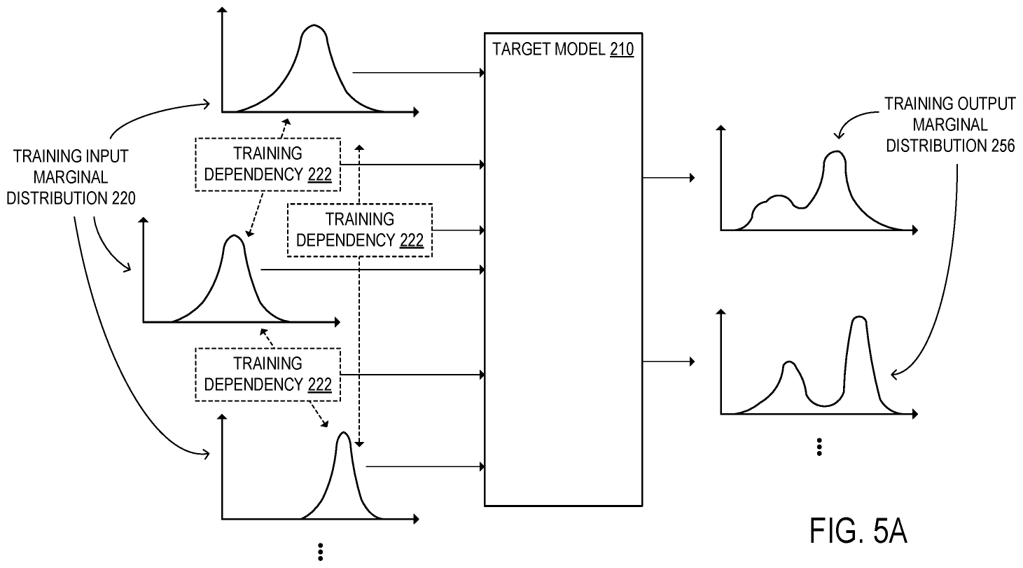

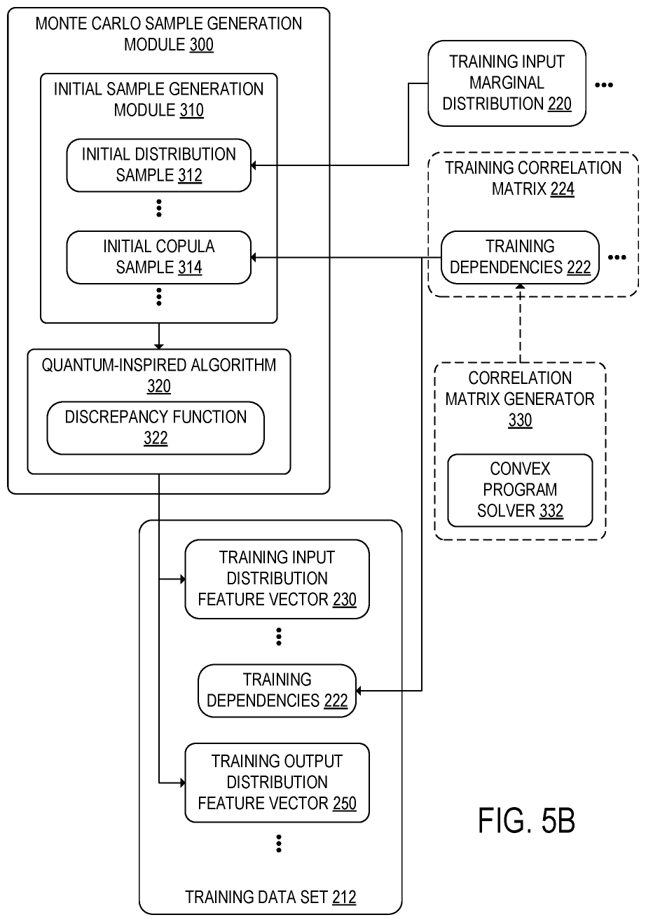

FIG. 5A schematically shows a target model 210 that the first trained machine learning model 40 is trained to reproduce, as discussed in further detail below. The target model 210 may be a stochastic model or a rule-based computational model. The target model 210 is shown during generation of training data with which the first trained machine learning model 40 is configured to be trained. As shown in FIG. 5A, the target model 210 may be configured to receive a plurality of training input marginal distributions 220 and one or more training dependencies 222 between the training input marginal distributions 220. The one or more training dependencies 222 may be correlation coefficients or some other type of dependency indications. The target model 210 may be configured to output a plurality of training output marginal distributions 256 that may be used to provide ground truth to the first trained machine learning model 40 during training. When the training data is generated, the one or more processors 12 may be configured to generate a plurality of sets of training input marginal distributions 220, training dependencies 222, and corresponding training output marginal distributions 256.

In some examples, at least a portion of the plurality of training input marginal distributions 220 may include empirical data. Additionally or alternatively, at least a portion of the plurality of training input marginal distributions 220 may be synthetically generated. In examples in which at least a portion of the plurality of training input marginal distributions 220 are synthetically generated, the plurality of training input marginal distributions 220 may, for example, be beta, gamma, lognormal, normal, Pareto, uniform, Weibull, Bernoulli, binomial, Poisson, negative binomial, or some other type of probability distributions.

A training data set 212 with which the first trained machine learning model 40 may be trained is schematically shown in FIG. 5B, according to the example of FIG. 5A. As depicted in the example of FIG. 5B, the one or more processors 12 may be configured to synthetically generate the plurality of training input distributions feature vectors 230 and training output distribution feature vectors 250 at a Monte Carlo sample generation module 300. The example Monte Carlo sample generation module shown in FIG. 5B includes an initial sample generation module 310 and a quantum-inspired algorithm 320. Examples of suitable quantum-inspired algorithms include simulated annealing, simulated quantum annealing, population annealing, and parallel tempering. Each of these utilizes a temperature parameter to control the extent to which the Monte Carlo algorithm is allowed to accept random proposed values with greater cost than at a prior timestep, according to an accept/reject policy. At the initial sample generation module 310, the one or more processors 12 may be configured according to the plurality of training input marginal distributions 220 and one or more training dependencies 222 to perform rank matching to generate a set of initial distribution samples 312 and a set of initial copula samples 314 that are output to the quantum-inspired algorithm 320.

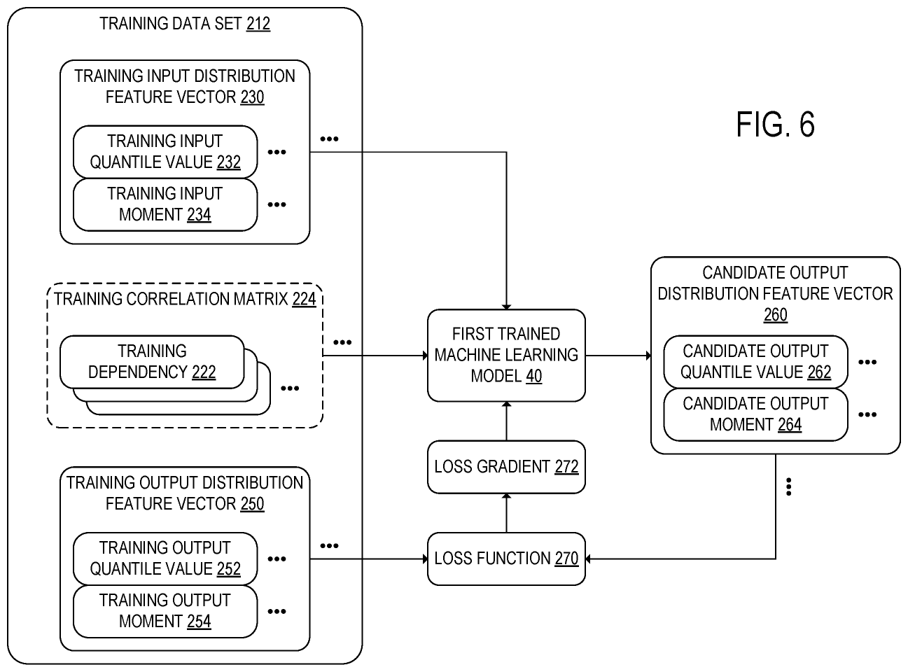

At the quantum-inspired algorithm 320, the one or more processors 12 may be further configured to iteratively replace initial distribution samples and initial copula samples included in the sets generated by the initial sample generation module 310 such that a value of a discrepancy function 322 of the quantum-inspired algorithm 320 is decreased. Reducing the value of the discrepancy function 322 may allow the training output distribution feature vectors 250 to represent the training output marginal distributions more accurately 256. The quantum-inspired algorithm 320 may be configured to output a plurality of training input distribution feature vectors 230 and one or more training output distribution features vectors 250. As shown in the example of FIG. 6, the plurality of training input distribution feature vectors 230 may each include a plurality of training input quantile values 232 and a plurality of training input moments 234 and the plurality of training output distribution feature vectors 250 may each include a plurality of training output quantile values 252 and a plurality of training output moments 254.

Returning to the example of FIG. 5B, when the training data set 212 is generated, the one or more processors 12 may, in some examples, be further configured to execute a correlation matrix generator 330 to generate training dependencies 222. At the correlation matrix generator 330, one or more processors 12 may be configured to execute a convex program solver 332 at which a training correlation matrix 224 for the training dependency 222 corresponding to the training input distribution feature vectors 230 is generated.

FIG. 6 schematically shows the first trained machine learning model 40 during a training phase that occurs prior to the runtime phase. In the training phase, the one or more processors 12 may be further configured to train the first trained machine learning model 40 using the training data set 212 to reproduce outputs of the target model 210. The training phase may include a plurality of training iterations. During each training iteration, the first trained machine learning model 40 may be configured to receive a training input distribution feature vector 230 and corresponding training dependencies 222. In some examples, the training dependencies 222 may be encoded in a training correlation matrix 224. The first trained machine learning model 40 may be further configured to compute, based at least in part on the training input distribution feature vector 230 and the training dependencies 222, a candidate output distribution feature vector 260. The candidate output distribution feature vector 260 may include a plurality of candidate output quantile values 262 and a plurality of candidate output moments 264.

During each training iteration included in the training phase, the one or more processors 12 may be further configured to compute a value of a loss function 270 based at least in part on the training output distribution feature vector 250 and the candidate output distribution feature vector 260. The loss function 270 may be a measure of a distance (e.g. an L1 or L2 norm) between the training output distribution feature vector 250 and the candidate output distribution feature vector 260. The one or more processors 12 may be further configured to compute a loss gradient 272 from the value of the loss function 270 and perform gradient descent at the first trained machine learning model 40 to update one or more parameters of the first trained machine learning model 40 based at least in part on the loss gradient 272. Accordingly, the one or more processors 12 may be configured to train the first trained machine learning model 40 to output candidate output distribution feature vectors 260 that approximately match the training output distribution feature vectors 250, thereby simulating the target model 210.

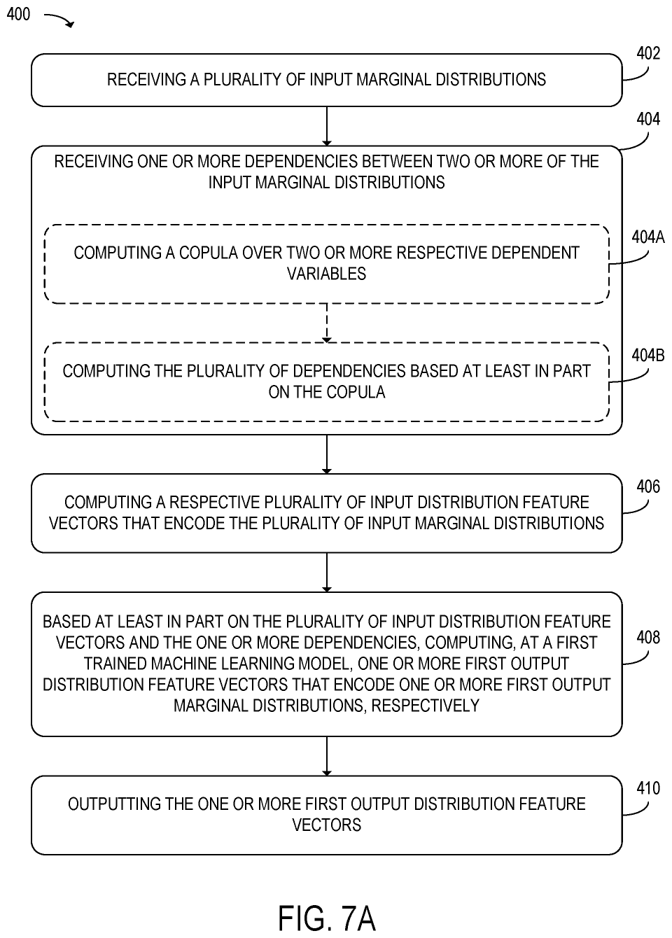

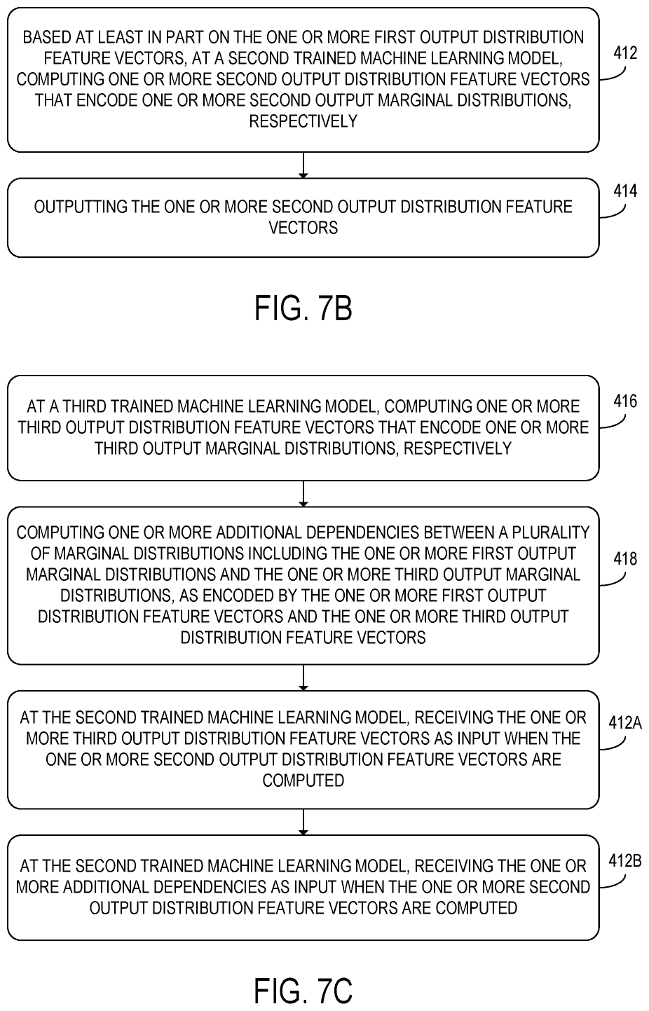

Turning now to FIG. 7A, a flowchart of an example method 400 for use with a computing system is provided. The method 400 includes steps performed at the computing system during a runtime phase. At step 402, the method 400 may include receiving a plurality of input marginal distributions. The plurality of input marginal distributions may each be probability distributions or frequency distributions of a dependent variable as a function of an independent variable.

At step 404, the method 400 may further include receiving one or more dependencies between two or more of the input marginal distributions. In some examples, the one or more dependencies between the two or more input marginal distributions may be correlation coefficients between pairs of the input marginal distributions. These correlation coefficients may be indicated in a correlation matrix.

When step 404 is performed, steps 404A and 404B may be computed in some examples. At step 404A, the method 400 may further include computing a copula over two or more respective variables. The copula may, for example, be a Gaussian copula, Clayton copula, Gumbel copula, T copula, or some other type of copula. In some examples, at least a portion of the data included in the copula may be empirical data. At step 404B, the method 400 may further include computing the one or more dependencies based at least in part on the copula. Thus, in examples in which steps 404A and 404B are performed, preprocessing may be performed on an input copula to obtain the dependencies between the input marginal distributions.

At step 406, the method 400 may further include computing a respective plurality of input distribution feature vectors that encode the plurality of input marginal distributions. Each input distribution feature vector may include a plurality of input quantile values and a plurality of input moments for the corresponding input marginal distribution. The input distribution feature vector may, for example, include five input quantile values and five input moments for the input marginal distribution. Alternatively, each input distribution feature vector may include a plurality of coordinates of a spline or a plurality of coefficients of a mixture model. Accordingly, the input marginal distribution may be compressed in a manner that allows the input marginal distribution to be more efficiently processed at a machine learning model.

At step 408, the method 400 may further include computing, at a first trained machine learning model, one or more first output distribution feature vectors that encode one or more first output marginal distributions, respectively. The one or more first output distribution feature vectors may be computed based at least in part on the plurality of input distribution feature vectors and the one or more dependencies. Each output distribution feature vector may include, for a corresponding first output marginal distribution, a plurality of output quantile values and a plurality of output moments. For example, the first output distribution feature vectors may have a same format as the input distribution feature vectors. At step 410, the method 400 may further include outputting the one or more first output distribution feature vectors. The one or more first output distribution feature vectors may be output to an additional computing process such as a GUI generation module.

FIGS. 7B-7C show additional steps of the method 400 that may be performed in examples in which the respective inputs and outputs of a plurality of trained machine learning models are chained together. FIG. 7B shows additional steps that may be performed when a second trained machine learning model is executed at the computing system. At step 412, the method 400 may further include computing one or more second output distribution feature vectors at a second trained machine learning model based at least in part on the one or more first output distribution feature vectors. The one or more second output distribution feature vectors may respectively encode one or more second output marginal distributions. At step 414, the method 400 may further include outputting the one or more second output distribution feature vectors.

The one or more second output distribution feature vectors may each include a respective plurality of output quantile values and a respective plurality of output moments. In some examples, the one or more second output distribution feature vectors may each have the same format as the plurality of input distribution feature vectors and/or the one or more first output distribution feature vectors.

FIG. 7C shows additional steps of the method 400 that may be performed in examples in which a third trained machine learning model is executed at the computing system, according to the example of FIG. 7B. At step 416, the method 400 may further include one or more third output distribution feature vectors at the third trained machine learning model. The one or more third output distribution feature vectors may encode one or more third output marginal distributions, respectively. The one or more third output distribution feature vectors may be computed based at least in part on a plurality of third input distribution feature vectors.

Similarly to the one or more first output distribution feature vectors, the one or more third output distribution feature vectors may each include a plurality of output quantile values and a plurality of output moments. The one or more third output distribution feature vectors may each have the same format as the one or more first output distribution feature vectors.

At step 418, the method 400 may further include computing one or more additional dependencies between a plurality of marginal distributions including the one or more first output marginal distributions and the one or more third output marginal distributions, as encoded by the one or more first output distribution feature vectors and the one or more third output distribution feature vectors. The plurality of additional dependencies, in some examples, may be expressed as additional correlation coefficients included in an additional correlation matrix. In some examples, computing the plurality of additional dependencies may include computing an additional copula over two or more dependent variables. In such examples, the additional correlation matrix may be generated based at least in part on the additional copula.

The method 400 may further include steps that are performed when the one or more second output distribution feature vectors are computed at step 412. At step 412A, the method 400 may further include receiving the one or more third output distribution feature vectors as input at the second trained machine learning model when the one or more second output distribution feature vectors are computed. In addition, the method 400 may further include, at step 412B, receiving the one or more additional dependencies as input at the second trained machine learning model when the one or more second output distribution feature vectors are computed. Thus, the inputs to the second trained machine learning model may include the one or more first output distribution feature vectors, the one or more third output distribution feature vectors, and one or more additional dependencies. Distribution feature vectors received from one or more additional machine learning models or received from a computing process other than a machine learning model may additionally or alternatively be received as input at the second trained machine learning model. The stages in which the distribution feature vectors are processed may be arranged in any directed acyclic graph.

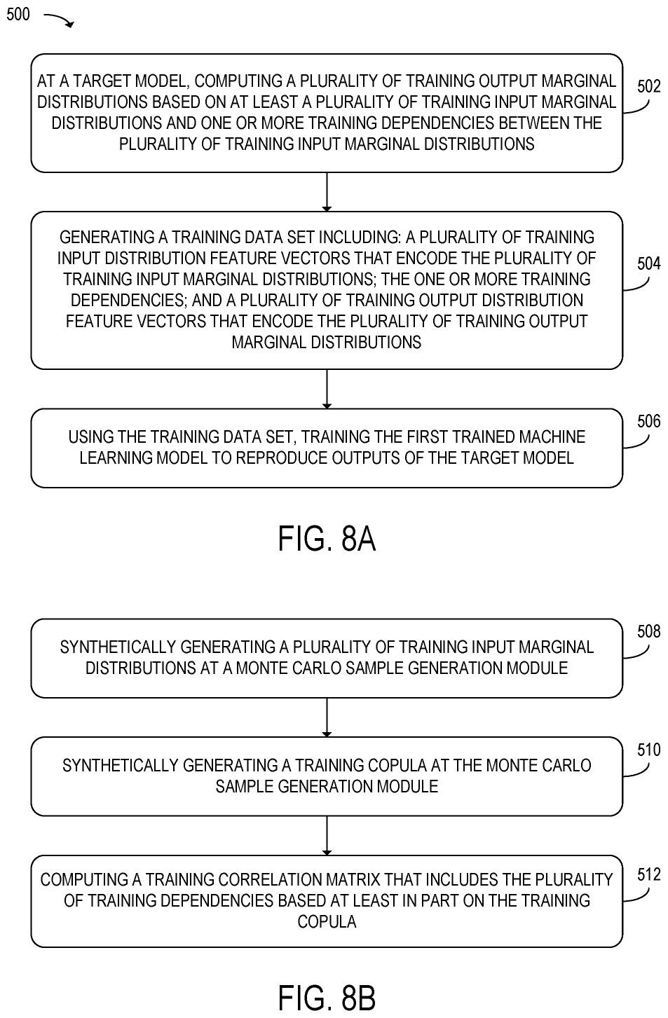

FIG. 8A shows a flowchart of an example method 500 by which the first trained machine learning model may be trained at the computing system during a training phase that occurs prior to the runtime phase. At step 502, the method 500 may include computing a plurality of training output marginal distributions at a target model. The plurality of training output distributions may be computed based on at least a plurality of training input marginal distributions and one or more training dependencies between the plurality of training input marginal distributions. For example, the one or more training dependencies may be one or more training correlation coefficients included in a training correlation matrix. The target model may be a machine learning model or may alternatively be some other type of computational model that does not utilize machine learning.

At step 504, the method 500 may further include generating a training data set for the first trained machine learning model. The training data set may include a plurality of training input distribution feature vectors that encode the plurality of training input marginal distributions. In some examples, the plurality of training input distribution feature vectors may be computed by compressing the plurality of training input marginal distributions. In other examples, the plurality of training input marginal distributions that are used as inputs to the target model may be computed from the training input distribution feature vectors. The training data set may further include one or more training dependencies between the training input marginal distributions. In addition, the training data set may further include a plurality of training output distribution feature vectors that encode the plurality of training output marginal distributions. The plurality of training output distribution feature vectors may be computed from the training output marginal distributions output by the target model.

At step 506, the method 500 may further include training the first trained machine learning model using the training data set to reproduce outputs of the target model. Step 506 may include a plurality of training iterations in which the first trained machine learning model generates one or more candidate output distribution feature vectors based at least in part on a plurality of training input distribution feature vectors and the one or more training dependencies. The one or more candidate output distribution feature vectors and one or more corresponding training output distribution feature vectors may be used as inputs to compute a value of a loss function that indicates a distance between the one or more candidate output distribution feature vectors and the one or more training output distribution feature vectors.

FIG. 8B shows additional steps of the method 500 of FIG. 8A that may be performed in some examples when generating the training data set for the first trained machine learning model. The steps of FIG. 8B may be performed prior to the steps of FIG. 8A. At step 508, the method 500 may further include synthetically generating a plurality of training input marginal distributions at a Monte Carlo sample generation module. The plurality of training input marginal distributions may, for example, be beta, gamma, lognormal, normal, Pareto, uniform, Weibull, Bernoulli, binomial, Poisson, negative binomial, or some other type of probability distributions. In examples in which step 508 is performed, the method 500 may further include, at step 510, synthetically generating a training copula at the Monte Carlo sample generation module. The Monte Carlo sample generation module may, for example, include an initial sample generation module and a quantum-inspired algorithm. At step 512, the method 500 may further include computing a training correlation matrix that includes the one or more training dependencies based at least in part on the training copula. Thus, the inputs to the target model may be generated.

In some examples, additionally or alternatively to the synthetically generated training input marginal distributions generated in the steps shown in FIG. 7B, at least a portion of the plurality of training input marginal distributions may include empirical data.

According to one example use case scenario, the target model may be an electrical power supply forecasting model. In this example, the input marginal distributions may be probability distributions of weather conditions. For example, the input marginal distributions may indicate probabilities of different ranges for temperature, rainfall, level of cloud cover, and wind speed. As weather conditions are consequences of individual weather events, the input marginal distributions may be correlated. The output marginal distributions may be probability distributions of the amounts of electrical power available from different power sources, such as solar, wind, and hydroelectric power. The different power sources indicated in the output marginal distributions may correspond to different methods of generating electrical power or may correspond to specific physical installations at which electrical power may be generated. At the target model, the one or more processors may be configured to generate predicted distributions of the available amounts of different sources of electrical power as a function of the input distributions of weather conditions. The one or more processors may be further configured to train a first trained machine learning model to simulate the target model. Accordingly, at the first trained machine learning model, the one or more processors may be configured to generate predicted distributions of electrical power source availability more quickly and with fewer computing resources relative to the target model.

In another example use case scenario, the target model may be configured to output distributions of financial risk in an insurance setting. The target model may, for example, be configured to output a distribution of an insurer's aggregate loss. The input marginal distributions in this example may be probability or frequency distributions of different types of insurance claims. Since large-scale events such as wildfires and floods may lead to large numbers of insurance claims, the input marginal distributions may be correlated. In addition, the target model may exhibit nonlinear behaviors when modeling systems such as reinsurance. By simulating the target model with the first trained machine learning model, updated predictions of aggregate risk may be generated more quickly, thereby allowing users to adapt their decision-making in real time or near-real time.

In a third example use case scenario, the target model may be configured to output distributions of predicted demand for products in a supply chain. The input marginal distributions may be forecasted demand for stock keeping units (“SKUs”) across different customer localities. Natural and human factors, such as weather events or traditional preferences, may lead to the distributions of nearby localities being correlated. The target model may be set to output the distribution of aggregate demand across a region. By simulating the target model with the first trained machine learning model, forecasts of regional product demand can be more quickly generated, thereby allowing decision-making as to inventory pooling and safety stock placement for large-scale inventory management.

Using the systems and methods discussed above, marginal distributions that are used as inputs or generated as outputs of models of stochastic processes may be compressed by encoding them as distribution feature vectors. This encoding may allow machine learning models simulating those models to be trained more quickly and with fewer computing resources. Accordingly, the distribution feature vector encoding may allow for training of machine learning models that efficiently simulate complex models of stochastic processes.

In some embodiments, the methods and processes described herein may be tied to a computing system of one or more computing devices. In particular, such methods and processes may be implemented as a computer-application program or service, an application-programming interface (API), a library, and/or other computer-program product.

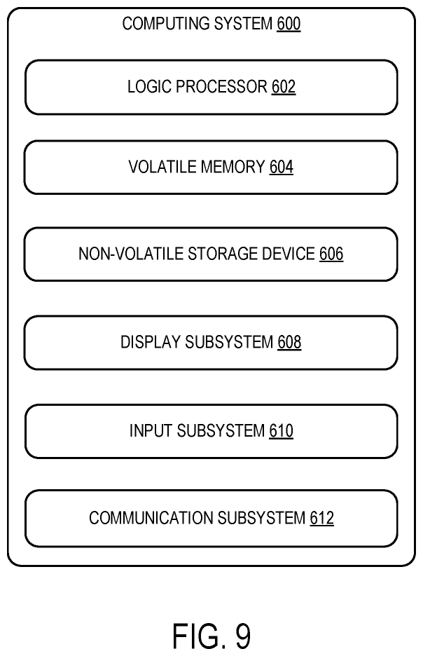

FIG. 9 schematically shows a non-limiting embodiment of a computing system 600 that can enact one or more of the methods and processes described above. Computing system 600 is shown in simplified form. Computing system 600 may embody the computing system 10 described above and illustrated in FIG. 2. Components of the computing system 600 may be included in one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 600 includes a logic processor 602 volatile memory 604, and a non-volatile storage device 606. Computing system 600 may optionally include a display subsystem 608, input subsystem 610, communication subsystem 612, and/or other components not shown in FIG. 9.

Logic processor 602 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 602 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 606 includes one or more physical devices configured to hold instructions executable by the logic processors to implement the methods and processes described herein. When such methods and processes are implemented, the state of non-volatile storage device 606 may be transformed—e.g., to hold different data.

Non-volatile storage device 606 may include physical devices that are removable and/or built-in. Non-volatile storage device 606 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 606 may include nonvolatile, dynamic, static, read/write, read-only, sequential-access, location-addressable, file-addressable, and/or content-addressable devices. It will be appreciated that non-volatile storage device 606 is configured to hold instructions even when power is cut to the non-volatile storage device 606.

Volatile memory 604 may include physical devices that include random access memory. Volatile memory 604 is typically utilized by logic processor 602 to temporarily store information during processing of software instructions. It will be appreciated that volatile memory 604 typically does not continue to store instructions when power is cut to the volatile memory 604.

Aspects of logic processor 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via logic processor 602 executing instructions held by non-volatile storage device 606, using portions of volatile memory 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 608 may be used to present a visual representation of data held by non-volatile storage device 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with logic processor 602, volatile memory 604, and/or non-volatile storage device 606 in a shared enclosure, or such display devices may be peripheral display devices.

When included, input subsystem 610 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 600 to send and/or receive messages to and/or from other devices via a network such as the Internet.

The following paragraphs discuss several aspects of the present disclosure. According to one aspect of the present disclosure, a computing system is provided, including one or more processors configured to, during a runtime phase, receive a plurality of input marginal distributions. The one or more processors may be further configured to receive one or more dependencies between two or more of the input marginal distributions. The one or more processors may be further configured to compute a respective plurality of input distribution feature vectors that encode the plurality of input marginal distributions. Based at least in part on the plurality of input distribution feature vectors and the one or more dependencies, the one or more processors may be further configured to compute, at a first trained machine learning model, one or more first output distribution feature vectors that encode one or more first output marginal distributions, respectively. The one or more processors may be further configured to output the one or more first output distribution feature vectors. A potential technical advantage of such a configuration is that the first output marginal distributions may be estimated more quickly and efficiently on processor hardware than with some other types of marginal distribution simulation models.

According to this aspect, each input distribution feature vector of the plurality of input distribution feature vectors may include, for a corresponding input marginal distribution of the plurality of input marginal distributions, a plurality of input quantile values and a plurality of input moments, a plurality of coordinates of a spline, or a plurality of coefficients of a mixture model. A potential technical advantage of such a configuration is that different types of features of the input marginal distributions may be represented in the inputs to the first trained machine learning model.

According to this aspect, each output distribution feature vector of the one or more first output distribution feature vectors may include, for a corresponding first output marginal distribution of the one or more first output marginal distributions, a plurality of output quantile values and a plurality of output moments. A potential technical advantage of such a configuration is that the first output distribution feature vectors may parametrize the first output marginal distributions.

According to this aspect, the one or more processors may be further configured to, at a second trained machine learning model, compute one or more second output distribution feature vectors that encode one or more second output marginal distributions, respectively. The one or more second output distribution feature vectors may be computed based at least in part on the one or more first output distribution feature vectors. The one or more processors may be further configured to output the one or more second output distribution feature vectors. A potential technical advantage of such a configuration is that a toolchain of multiple high-compute-cost simulation models may be simulated efficiently with multiple trained machine learning models chained together.

According to this aspect, at a third trained machine learning model, the one or more processors may be further configured to compute one or more third output distribution feature vectors that encode one or more third output marginal distributions, respectively. The second trained machine learning model may be further configured to receive the one or more third output distribution feature vectors as input when the one or more second output distribution feature vectors are computed. A potential technical advantage of such a configuration is that a toolchain of multiple high-compute-cost simulation models may be simulated efficiently with multiple trained machine learning models arranged in a directed acyclic graph.

According to this aspect, the one or more processors may be further configured to compute one or more additional dependencies between a plurality of marginal distributions including the one or more first output marginal distributions and the one or more third output marginal distributions, as encoded by the one or more first output distribution feature vectors and the one or more third output distribution feature vectors. The second trained machine learning model is further configured to receive the one or more additional dependencies as input when the one or more second output distribution feature vectors are computed. A potential technical advantage of such a configuration is that additional correlations between the distribution feature vectors received as inputs at a trained machine learning model may be reflected in the outputs of that trained machine learning model.

According to this aspect, the one or more dependencies between the two or more the input marginal distributions may be correlation coefficients between pairs of the input marginal distributions that are indicated in a correlation matrix. A potential technical advantage of such a configuration is that the dependencies may be represented in a form in which they may be used as inputs at the first trained machine learning model.

According to this aspect, the one or more processors may be further configured to compute the one or more dependencies between the two or more input marginal distributions at least in part by computing a copula over two or more respective dependent variables. A potential technical advantage of such a configuration is that the dependencies may be estimated from the input marginal distributions.

According to this aspect, during a training phase that occurs prior to the runtime phase, the one or more processors are further configured to train the first trained machine learning model at least in part by, at a target model, computing a plurality of training output marginal distributions based on at least a plurality of training input marginal distributions and one or more training dependencies between the plurality of training input marginal distributions. Training the first training machine learning model may further include generating a training data set including a plurality of training input distribution feature vectors that encode the plurality of training input marginal distributions. The training data set may further include the one or more training dependencies. The training data set may further include a plurality of training output distribution feature vectors that encode the plurality of training output marginal distributions. Training the first training machine learning model may further include, using the training data set, training the first trained machine learning model to reproduce outputs of the target model. A potential technical advantage of such a configuration is that the first trained machine learning model may be trained to simulate the behavior of a target model that may be slower and less efficient than the first trained machine learning model.

According to this aspect, at least a portion of the plurality of training input marginal distributions may include empirical data. A potential technical advantage of such a configuration is that the first trained machine learning model may be trained to simulate an empirical process.

According to this aspect, the one or more processors may be configured to synthetically generate at least a portion of the plurality of training input marginal distributions at a Monte Carlo sample generation module. A potential technical advantage of such a configuration is that the first trained machine learning model may be trained to accurately represent correlations in the first output distribution feature vectors without the user having to collect large amounts of empirical correlation data to use as training data.

According to another aspect of the present disclosure, a method for use with a computing system is provided. The method may be computer-implemented. The method may include, during a runtime phase, receiving a plurality of input marginal distributions. The method may further include receiving one or more dependencies between two or more of the input marginal distributions. The method may further include computing a respective plurality of input distribution feature vectors that encode the plurality of input marginal distributions. Based at least in part on the plurality of input distribution feature vectors and the one or more dependencies, the method may further include computing, at a first trained machine learning model, one or more first output distribution feature vectors that encode one or more first output marginal distributions, respectively. The method may further include outputting the one or more first output distribution feature vectors. A potential technical advantage of such a configuration is that the first output marginal distributions may be estimated more quickly and efficiently than with some other types of marginal distribution simulation models.

According to this aspect, each input distribution feature vector of the plurality of input distribution feature vectors may include, for a corresponding input marginal distribution of the plurality of input marginal distributions, a plurality of input quantile values and a plurality of input moments, a plurality of coordinates of a spline, or a plurality of coefficients of a mixture model. A potential technical advantage of such a configuration is that different types of features of the input marginal distributions may be represented in the inputs to the first trained machine learning model.

According to this aspect, each output distribution feature vector of the one or more first output distribution feature vectors may include, for a corresponding first output marginal distribution of the one or more first output marginal distributions, a plurality of output quantile values and a plurality of output moments. A potential technical advantage of such a configuration is that the first output distribution feature vectors may parametrize the first output marginal distributions.

According to this aspect, the method may further include, at a second trained machine learning model, computing one or more second output distribution feature vectors that encode one or more second output marginal distributions, respectively. The one or more second output distribution feature vectors may be computed based at least in part on the one or more first output distribution feature vectors. The method may further include outputting the one or more second output distribution feature vectors. A potential technical advantage of such a configuration is that a toolchain of multiple high-compute-cost simulation models may be simulated efficiently with multiple trained machine learning models chained together.

According to this aspect, the method may further include, at a third trained machine learning model, computing one or more third output distribution feature vectors that encode one or more third output marginal distributions, respectively. The method may further include computing one or more additional dependencies between a plurality of marginal distributions including the one or more first output marginal distributions and the one or more third output marginal distributions, as encoded by the one or more first output distribution feature vectors and the one or more third output distribution feature vectors. At the second trained machine learning model, when the one or more second output distribution feature vectors are computed, the method may further include receiving the one or more third output distribution feature vectors and the one or more additional dependencies as input. A potential technical advantage of such a configuration is that a toolchain of multiple high-compute-cost simulation models may be simulated efficiently with multiple trained machine learning models arranged in a directed acyclic graph.

According to this aspect, the one or more dependencies between the two or more input marginal distributions may be correlation coefficients between pairs of the input marginal distributions that are indicated in a correlation matrix. A potential technical advantage of such a configuration is that the dependencies may be represented in a form in which they may be used as inputs at the first trained machine learning model.

According to this aspect, the method may further include computing the one or more dependencies between the two or more input marginal distributions at least in part by computing a copula over two or more respective dependent variables. A potential technical advantage of such a configuration is that the dependencies may be estimated from the input marginal distributions.

According to this aspect, the method may further include training the first trained machine learning model during a training phase that occurs prior to the runtime phase. Training the first trained machine learning model may include, at a target model, computing a plurality of training output marginal distributions based on at least a plurality of training input marginal distributions and one or more training dependencies between the plurality of training input marginal distributions. Training the first trained machine learning model may further include generating a training data set including a plurality of training input distribution feature vectors that encode the plurality of training input marginal distributions. The training data set may further include the one or more training dependencies. The training data set may further include a plurality of training output distribution feature vectors that encode the plurality of training output marginal distributions. Training the first trained machine learning model may further include, using the training data set, training the first trained machine learning model to reproduce outputs of the target model. A potential technical advantage of such a configuration is that the first trained machine learning model may be trained to simulate the behavior of a target model that may be slower and less efficient than the first trained machine learning model.

According to another aspect of the present disclosure, a computing system is provided, including one or more processors configured to, during a runtime phase, receive a plurality of input marginal distributions. The one or more processors may be further configured to receive a correlation matrix indicating one or more correlation coefficients for respective pairs of the input marginal distributions. The one or more processors may be further configured to compute a respective plurality of input distribution feature vectors that encode the plurality of input marginal distributions. Each of the plurality of input distribution feature vectors may include a respective plurality of input quantile values and a respective plurality of input moments. Based at least in part on the plurality of input distribution feature vectors and the plurality of correlation coefficients, the one or more processors may be further configured to compute, at a trained machine learning model, one or more first output distribution feature vectors that encode one or more output marginal distributions, respectively. Each of the one or more output distribution feature vectors may include a respective plurality of output quantile values and a respective plurality of output moments. The one or more processors may be further configured to output the one or more first output distribution feature vectors. A potential technical advantage of such a configuration is that the first output marginal distributions may be estimated more quickly and efficiently than with some other types of marginal distribution simulation models.

Features which are described in the context of separate aspects and embodiments of the invention may be used together and/or be interchangeable. Similarly, where features are, for brevity, described in the context of a single embodiment, these may also be provided separately or in any suitable sub-combination. Features described in connection with the system may have corresponding features definable with respect to the method(s), and vice versa, and these embodiments are specifically envisaged.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processors configured to, during a runtime phase:
receive a plurality of input marginal distributions;
receive one or more dependencies between two or more of the input marginal distributions;
compute a respective plurality of input distribution feature vectors that encode the plurality of input marginal distributions;
based at least in part on the plurality of input distribution feature vectors and the one or more dependencies, compute, at a first trained machine learning model, one or more first output distribution feature vectors that encode one or more first output marginal distributions, respectively; and
output the one or more first output distribution feature vectors.

2. The computing system of claim 1, wherein each input distribution feature vector of the plurality of input distribution feature vectors includes, for a corresponding input marginal distribution of the plurality of input marginal distributions:
a plurality of input quantile values and a plurality of input moments;
a plurality of coordinates of a spline; or
a plurality of coefficients of a mixture model.

3. The computing system of claim 2, wherein each output distribution feature vector of the one or more first output distribution feature vectors includes, for a corresponding first output marginal distribution of the one or more first output marginal distributions, a plurality of output quantile values and a plurality of output moments.

4. The computing system of claim 1, wherein the one or more processors are further configured to:
based at least in part on the one or more first output distribution feature vectors, at a second trained machine learning model, compute one or more second output distribution feature vectors that encode one or more second output marginal distributions, respectively; and
output the one or more second output distribution feature vectors.

5. The computing system of claim 4, wherein:
at a third trained machine learning model, the one or more processors are further configured to compute one or more third output distribution feature vectors that encode one or more third output marginal distributions, respectively; and
the second trained machine learning model is further configured to receive the one or more third output distribution feature vectors as input when the one or more second output distribution feature vectors are computed.

6. The computing system of claim 5, wherein:
the one or more processors are further configured to compute one or more additional dependencies between a plurality of marginal distributions including the one or more first output marginal distributions and the one or more third output marginal distributions, as encoded by the one or more first output distribution feature vectors and the one or more third output distribution feature vectors;
the second trained machine learning model is further configured to receive the one or more additional dependencies as input when the one or more second output distribution feature vectors are computed.

7. The computing system of claim 1, wherein the one or more dependencies between the two or more the input marginal distributions are correlation coefficients between pairs of the input marginal distributions that are indicated in a correlation matrix.

8. The computing system of claim 1, wherein the one or more processors are further configured to compute the one or more dependencies between the two or more input marginal distributions at least in part by computing a copula over two or more respective dependent variables.

9. The computing system of claim 1, wherein, during a training phase that occurs prior to the runtime phase, the one or more processors are further configured to train the first trained machine learning model at least in part by:
at a target model, computing a plurality of training output marginal distributions based on at least a plurality of training input marginal distributions and one or more training dependencies between the plurality of training input marginal distributions;
generating a training data set including:
a plurality of training input distribution feature vectors that encode the plurality of training input marginal distributions;
the one or more training dependencies; and
a plurality of training output distribution feature vectors that encode the plurality of training output marginal distributions; and
using the training data set, training the first trained machine learning model to reproduce outputs of the target model.

10. The computing system of claim 9, wherein at least a portion of the plurality of training input marginal distributions includes empirical data.

11. The computing system of claim 9, wherein the one or more processors are configured to synthetically generate at least a portion of the plurality of training input marginal distributions at a Monte Carlo sample generation module.

12. A method for use with a computing system, the method comprising, during a runtime phase:
receiving a plurality of input marginal distributions;
receiving one or more dependencies between two or more of the input marginal distributions;
computing a respective plurality of input distribution feature vectors that encode the plurality of input marginal distributions;
based at least in part on the plurality of input distribution feature vectors and the one or more dependencies, computing, at a first trained machine learning model, one or more first output distribution feature vectors that encode one or more first output marginal distributions, respectively; and
outputting the one or more first output distribution feature vectors.

13. The method of claim 12, wherein each input distribution feature vector of the plurality of input distribution feature vectors includes, for a corresponding input marginal distribution of the plurality of input marginal distributions:
a plurality of input quantile values and a plurality of input moments;
a plurality of coordinates of a spline; or
a plurality of coefficients of a mixture model.

14. The method of claim 13, wherein each output distribution feature vector of the one or more first output distribution feature vectors includes, for a corresponding first output marginal distribution of the one or more first output marginal distributions, a plurality of output quantile values and a plurality of output moments.

15. The method of claim 12, further comprising:
based at least in part on the one or more first output distribution feature vectors, at a second trained machine learning model, computing one or more second output distribution feature vectors that encode one or more second output marginal distributions, respectively; and
outputting the one or more second output distribution feature vectors.

16. The method of claim 15, further comprising:
at a third trained machine learning model, computing one or more third output distribution feature vectors that encode one or more third output marginal distributions, respectively;
computing one or more additional dependencies between a plurality of marginal distributions including the one or more first output marginal distributions and the one or more third output marginal distributions, as encoded by the one or more first output distribution feature vectors and the one or more third output distribution feature vectors; and
at the second trained machine learning model, when the one or more second output distribution feature vectors are computed, receiving the one or more third output distribution feature vectors and the one or more additional dependencies as input.

17. The method of claim 12, wherein the one or more dependencies between the two or more input marginal distributions are correlation coefficients between pairs of the input marginal distributions that are indicated in a correlation matrix.

18. The method of claim 12, further comprising computing the one or more dependencies between the two or more input marginal distributions at least in part by computing a copula over two or more respective dependent variables.

19. The method of claim 12, further comprising, during a training phase that occurs prior to the runtime phase, training the first trained machine learning model at least in part by:
at a target model, computing a plurality of training output marginal distributions based on at least a plurality of training input marginal distributions and one or more training dependencies between the plurality of training input marginal distributions;
generating a training data set including:
a plurality of training input distribution feature vectors that encode the plurality of training input marginal distributions;
the one or more training dependencies; and
a plurality of training output distribution feature vectors that encode the plurality of training output marginal distributions; and
using the training data set, training the first trained machine learning model to reproduce outputs of the target model.

20. A computing system comprising:
one or more processors configured to, during a runtime phase:
receive a plurality of input marginal distributions;
receive a correlation matrix indicating one or more correlation coefficients for respective pairs of the input marginal distributions;
compute a respective plurality of input distribution feature vectors that encode the plurality of input marginal distributions, wherein each of the plurality of input distribution feature vectors includes a respective plurality of input quantile values and a respective plurality of input moments;
based at least in part on the plurality of input distribution feature vectors and the plurality of correlation coefficients, compute, at a trained machine learning model, one or more first output distribution feature vectors that encode one or more output marginal distributions, respectively, wherein each of the one or more output distribution feature vectors includes a respective plurality of output quantile values and a respective plurality of output moments; and
output the one or more first output distribution feature vectors.
